(19) United States
(12) Patent Application Publication
(10) Pub. No.: US 2007/0043611 A1
(43) Pub. Date: Feb. 22, 2007

(54) Method for correlating marketing effectiveness in an interactive voice response system

(75) Inventors: Scott Newman, Little Elm, TX (US); John-Paul Roadman, Carrollton, TX (US); Jonathan Paden, Austin, TX (US); Richard Chuck Rhoades, Decatur, TX (US); Alex Yip, Plano, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/204,496

(22) Filed: Aug. 16, 2005

(51) Int. Cl. G06Q 30/00

(52) U.S. Cl. 705/14

(57) ABSTRACT

An interactive voice response system (IVR) (100) has a communications interface (110), a memory (104), and a controller (102). The controller is programmed to monitor (202) call volume by corresponding product, and correlate (206) extrinsic product advertisements to call volume.

### FIELD OF THE INVENTION

The present disclosure relates generally to correlation techniques in marketing, and more specifically to a method for correlating marketing effectiveness in an interactive voice response system (IVR).

### BACKGROUND

Companies utilizing IVRs for managing product sales, measure extrinsic marketing effectiveness (e.g., TV advertisements, magazine promotions, etc.) on the basis of product fulfillment results. This, however, fails to capture in real-time the reaction of consumers to product advertisements and promotions as they are deployed.

A need therefore arises for a method and apparatus to correlating marketing effectiveness in an IVR.

### BRIEF DESCRIPTION OF THE DRAWINGS

FIG. 1 is a block diagram of an IVR coupled to a communications network serving customer needs incorporating teachings of the present disclosure;

FIG. 2 depicts a flowchart of a method operating in the IVR incorporating teachings of the present disclosure; and

FIG. 3 is a diagrammatic representation of a machine in the form of a computer system within which a set of instructions, when executed, may cause the machine to perform any one or more of the methodologies discussed herein.

### DETAILED DESCRIPTION OF THE DRAWINGS

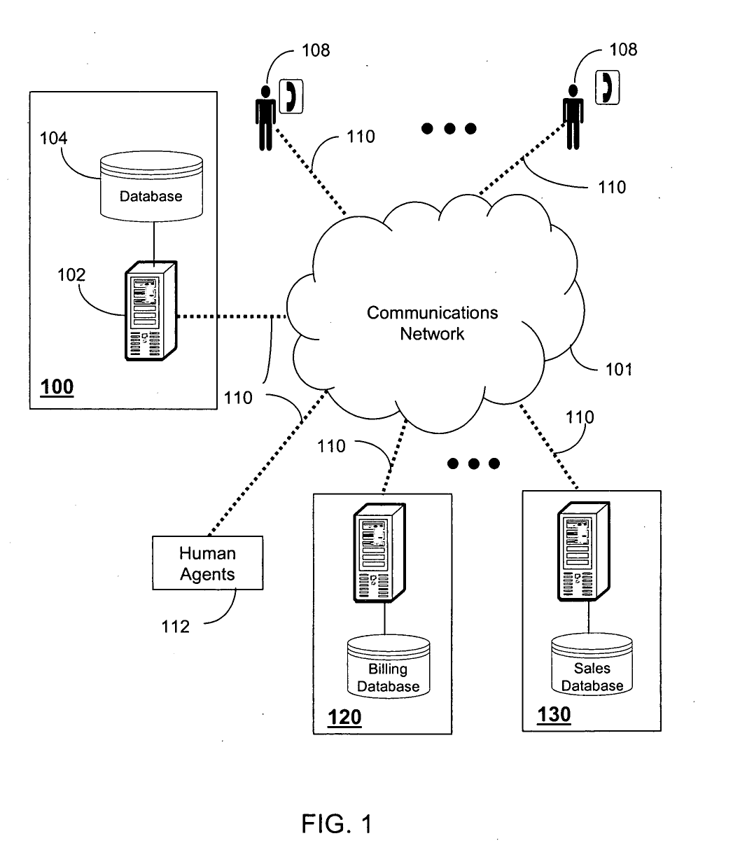

FIG. 1 is block diagram of an interactive voice response system (IVR) 100 coupled to a communications network 101 serving customers 108 incorporating teachings of the present disclosure. The IVR 100 comprises a communications interface 110, a memory 104 and a controller 102. The communications interface 110 utilizes conventional wired or wireless communications technology for interfacing to the communications network 101. The communications interface 110 can represent a circuit switched and/or a packet switched interface. Internet or traditional voice services can be provided by network 101 to customers 108. Accordingly, the communications network 101 can support multiple services such as: POTS (Plain Old Telephone Service), VoIP (Voice over Internet communications, IPTV (Internet Protocol Television), broadband communications, cellular telephony, and other known or future communication services.

The controller 102 utilizes conventional computing technology such as a desktop computer, or a scalable server. The memory 104 utilizes conventional mass storage media such as a high capacity disk drive, and can be used by the controller 102 to manage a database according to teachings of the present disclosure. The WVR 100 can also use conventional applications such as a CRM (Customer Relations Management) application for managing account information.

By way of the communications interface 110, the IVR 100 can access independently operated remote systems such as a billing system 120 and/or a sales recording system 130 for managing product services offered in the communications network 101. The IVR 100 can also perform updates on, for example, the billing system 120 as it processes customer calls according to teachings of the present disclosure. It will be appreciated that in the alternative the remote systems 120 and 130 can be in whole or in part an integral part of the IVR 100. Where the IVR 100 is unable to serve particular customer requests, it can direct such callers to one or more human agents 112 of the service provider as needed.

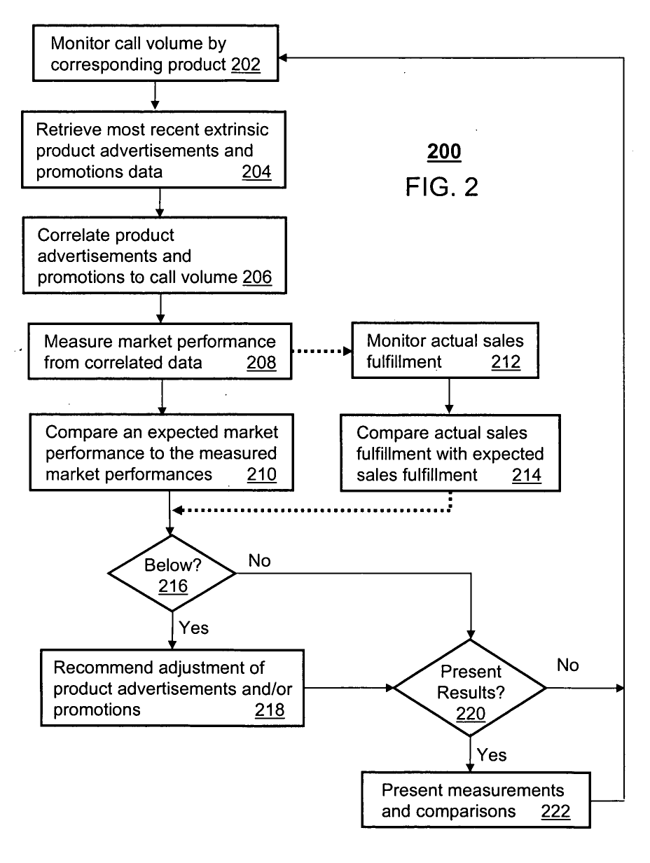

FIG. 2 depicts a flowchart of a method 200 operating in the IVR 100 incorporating teachings of the present disclosure. Method 200 begins with step 202 where the IVR 100 monitors call volume by corresponding product. A product can represent services or consumer goods that can be sold by way of the IVR 100. In step 204, the IVR 100 is programmed to retrieve information on the most recent extrinsic product advertisements and promotions. In the present context the term “extrinsic” means any advertising or promotional activity not circulated by the IVR 100. The term “advertisement” means any public announcement proclaiming the qualities or advantages of a product or service so as to increase sales. The term “promotion” means any collateral activity that furthers sales of products or services by way of, for example, discount coupons, limited offers, rebates, etc.

The information retrieved in step 204 is correlated in step 206 with the activities monitored in step 202 to identify in near real-time the effects of extrinsic product advertisements and promotions on product interest. Any conventional correlation algorithm may be used. Given the broad scope of correlation techniques and temporal and context points of application, it would be apparent to those with skill in the art that step 206 can take on any number of embodiments. For instance, the IVR 100 can perform a correlation analysis that determines the change in the volume of calls for a product according to a corresponding promotion and/or advertisement of said product known to be taking place at a particular time and location. The correlation analysis can be based for example on product interest whether or not a sales fulfillment of the product takes place.

Step 206 can be distinguished from prior art systems in which a caller is queried to identify his/her motivation for requesting product information, or perhaps consummating a sale. Steps 202 through 206 can operate as background processes which correlates extrinsic events with product requests without burdening prospective customers with surveys to determine their motivation for requesting a product. Random sampling, of course, can be performed whereby a few customers are asked if their call is related to a known advertisement or promotional event. Such a small sampling would not burden a large pool of customers and can be used to increase confidence in the correlation results of step 206.

In step 208, the IVR 100 can be programmed to measure market performance from the correlation data of step 206 and compare it in step 210 to an expected market performance established by the service provider. Market performance can correspond to any conventional measurement technique for assessing operational efficiency or profitability of an enterprise. For example, a market performance metric can be a measure of actual sales fulfillment by call volume as depicted in step 212 compared to an expected fulfillment in step 214. Step 214 can be derived from simple or complex statistical marketing techniques for predicting an expected performance. Alternatively, conventional performance metrics can be applied that relies, for instance, on segmented demographic and/or psychographic measurements, which are compared to, expected (or predicted) results.

In a supplemental embodiment, if measured results are detected in step 216 to be below expectation, then the IVR 100 can proceed to step 218 where it can use conventional techniques to recommend an adjustment to product advertisements or promotions. For this step any conventional self-learning, artificial intelligence, or automation technique can be utilized to make any useful recommendation. Because of the real-time aspect of aforementioned analysis, step 218 can serve as a means to cease or reduce advertisement and promotions if it is determined that its effectiveness is below expectation. Step 218 can therefore serve to mitigate cost for the service provider. Alternatively, step 218 can recommend a variable augmentation of existing extrinsic advertisement and promotions to improve sales. An artisan with ordinary skill in the art can anticipate that any conventional or future technique for improving a return on investment in relation to extrinsic advertisements and promotions can be applied to step 218.

From steps 216 or 218, the IVR 100 can be programmed in step 220 to detect a request for presentation from an agent (of the service provider) for the purposes of reviewing the results of the foregoing analysis. The IVR 100 can thus proceed to step 222 if a presentation is requested, or return to step 202 to repeat another cycle of method 200. The presentation step can be programmed such that the IVR 100 varies the amount of information presented to agents of the service provider according to a priority or status in the enterprise. Thus, some agents may be given complete access to all information, while others are presented partial results by, for example, region, product, gross sales, or some other limited information segment. The service provider's management staff can define such priority. The presentation step can also utilize any conventional technique for presenting graphical and/or numerical data for interpreting the results generate by method 200.

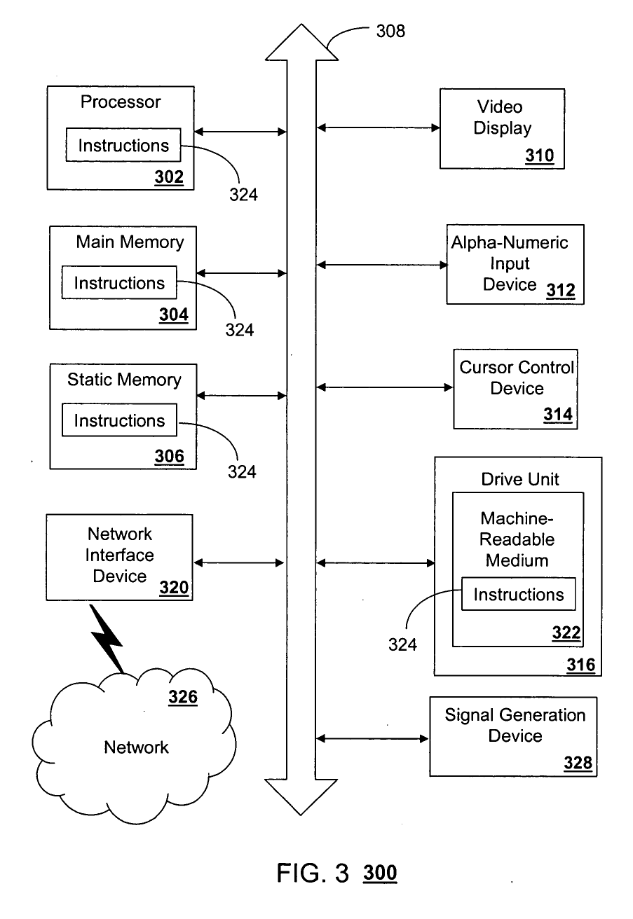

FIG. 3 is a diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated in herein above. The instructions 324 may also reside, completely or at least partially, within the main memory 304, the static memory 306, and/or within the processor 302 during execution thereof by the computer system 300. The main memory 304 and the processor 302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An interactive voice response system (IVR), comprising:
a communications interface;
a memory; and
a controller programmed to:
monitor call volume by corresponding product; and
correlate extrinsic product advertisements to call volume.

2. The IVR of claim 1, wherein the controller is programmed to measure a market performance from the correlated product advertisements.

3. The IVR of claim 1, wherein the controller is programmed to correlate extrinsic product promotions to call volume.

4. The IVR of claim 3, wherein the controller is programmed to measure a market performance from the correlated product promotions.

5. The IVR of claim 2, wherein the controller is programmed to monitor actual sales fulfillment by call volume.

6. The IVR of claim 5, wherein the controller is programmed to compare actual sales fulfillment with expected sales fulfillment.

7. The IVR of claim 2, wherein the controller is programmed to:
compare an expected market performance with the measured market performance for product advertisements; and
recommend an adjustment to product advertisements in response to the comparison step.

8. The IVR of claim 4, wherein the controller is programmed to:
compare an expected market performance with the measured market performance for product promotions; and
recommend an adjustment to product promotions.

9. The IVR of claim 1, wherein the controller is programmed to:
retrieve information on the most recent extrinsic product advertisements and product promotions;
correlate extrinsic product promotions to call volume;
measure a market performance for each of the correlated product advertisements and promotions;
compare an expected market performance with the measured market performances;
measure actual sales fulfillment by call volume;
compare the measured market performances with actual sales fulfillment;
receive a request to present results of the measurement and comparison steps; and
present a portion of the measurement and comparison steps according to a priority of the caller.

10. In an interactive voice response system (IVR) a computer-readable storage medium, comprising computer instructions for:
monitoring call volume by corresponding product; and
correlating in near real-time extrinsic product advertisements to call volume.

11. The storage medium of claim 10, comprising computer instructions for correlating product advertisements known to be taking place at a particular time to the monitored call volume.

12. The storage medium of claim 10, comprising computer instructions for correlating extrinsic product promotions known to be taking place at a particular time to the monitored call volume.

13. The storage medium of claim 12, comprising computer instructions for measuring a market performance from the correlated product promotions.

14. The storage medium of claim 11, comprising computer instructions for monitoring actual sales fulfillment by call volume.

15. The storage medium of claim 10, comprising computer instructions for:
sampling customers interacting with the IVR; and
surveying said customers to determine if their call is related to a known advertisement.

16. The storage medium of claim 10, comprising computer instructions for:
comparing an expected market performance with the measured market performance for product advertisements; and
recommending an adjustment to product advertisements.

17. The storage medium of claim 10, comprising computer instructions for:
sampling customers interacting with the IVR;
surveying said customers to determine if their call is related to a known promotion.

18. The storage medium of claim 16, comprising computer instructions for reducing product advertisements when the measured market performance for product advertisements is below the expected market performance.

19. The storage medium of claim 10, comprising computer instructions for presenting to one or more agents managing the IVR a portion of the correlation results according to a priority assigned to said agent affecting the type of information presented to said agents.

20. In an interactive voice response system (IVR), a method comprising the steps of:
monitoring call volume by corresponding product;
correlating at least one among extrinsic product advertisements and promotions to call volume;
measuring a market performance for each of the correlated product advertisements and promotions; and
comparing an expected market performance with the measured market performances.
